(19) United States
(12) Patent Application Publication
(10) Pub. No.: US 2003/0197094 A1
(43) Pub. Date: Oct. 23, 2003

(54) Load measuring device

(76) Inventor: Daniel Preston, Kew Gardens, NY (US)

Correspondence Address: MINTZ LEVIN COHN FERRIS GLOVSKY & POPEO, 666 THIRD AVENUE, NEW YORK, NY, 10017, US

(21) Appl. No.: 10/315,655

(22) Filed: Dec. 9, 2002

Related U.S. Application Data
(60) Provisional application No. 60/341,054, filed on Dec. 7, 2001.

(51) Int. Cl. B64D 17/00; B64D 19/00; B64D 21/00; B64D 23/00

(52) U.S. Cl. 244/142

(57) ABSTRACT

A miniaturized load measuring devices for use with parachutes is disclosed. The load measuring device includes a load link of a high strength steel having two tension beams between two connectors. The connectors attach the load measuring device to the harness, suspension line or other part of the parachute. Strain gauges are bonded to the two tension beams for determining to load forces on the load link. Electronic circuitry may be positioned within the load link between the two tension beams to process or amplify signals from the strain gauges.

### BACKGROUND OF THE INVENTION

1. Field of the Invention

The invention relates to generally load measuring devices interposed as a link in a tensioned strap. More particularly, it relates to a load measurement devices to determine forces exerted on a pilot, harness, suspension lines, or other parachute parts upon deployment of the parachute.

2. Discussion of Related Art

In the last several years, new canopy designs and skydiving styles have developed and gained popularity which involve higher free fall speeds and thus increase the deployment forces on the pilot and equipment. Ram air or wing-type parachutes are well known and commonly used by aviators and skydivers.

Traditionally, skydivers have fallen with their belly towards the earth. Competitions involved multiple participants linking up to form different patterns. Fall rates for traditional skydiving is about 120 mph. Most parachutes were designed to be deployed at such rates. However, new competitions and jump styles are now being used. In speed skydiving, competitors seek to fall the fastest. In sky-surfing, participants perform stunts during freefall using a board strapped to their feet. In free-fly, jumpers fly in a vertical direction with their heads pointing down. These new styles result in fall rates from 140 to 300 mph. However, deploying a parachute at higher speeds results in higher opening forces. The pilot is slowed more quickly since he or she starts as at a higher fall rate and subjected to more force. Theoretically, the jumper should slow decent before opening the parachute, but this often does not happen. Deployment of current parachutes from the higher flying speeds can result, and has resulted, in serious injuries and even death.

New parachute designs are being developed by the industry for use with higher flying speeds. However, the effects achieved by these new designs are hard to determine. There are no simple systems for measuring opening forces vs. time from a parachute. Existing systems position a load measurement device in the jumper's harness. The load measurement device is simply a deformable metal link which provides an indication of peak force. They cannot provide information about forces vs. time, which is the important information for determined the effects from the opening forces. Load links do exist for measuring tension on webbing in automotive seatbelts and on skydiving risers. But these designs are very large and bulky making their use in parachute testing difficult. Prior art load cells are too big to be used with standard skydiving rigs (harness/containers system) as they are too bulky to pack up. Additionally, existing designs lack accuracy and use external signal conditioning amplifiers. Therefore, a need exists for a simplified load measuring device which provides force vs. time information and can be accommodated in a jumper's harness.

Other types of load measuring devices are known, but cannot be easily adapted for use in a parachute environment for determining opening forces. Load measuring devices or load links are used to measure a load presented on a cable, chain or strap. Different types of load links are known. For example, U.S. Pat. No. 4, 283,942 discloses a load link formed as a link on a chain. The device is disposed within the center of the link and measures changes in width of the link to estimate loads on the chain. An alternative design includes a single, solid link with one or more strain gauges attached to parts of the link. The strain gauges are connected in a Wheatsone bridge to provide an voltage output corresponding to changes in length of the link. The voltage output can be used to determine the length change and, thus, the forces on the link. Typically, load links are substantially large. The link has to be sufficiently strong to support the load as well as elastically deformable for measurement purposes. Additionally, in order to reduce errors, the ratio of cross-section to length in the tension beam should be about 1:5. With a single beam and low tensile alloy this ratio must be kept very large. Prior art load cells use a low tensile metal like aluminum, yielding a large cross section and consequently long length and overall bulk. Additionally, a load link requires electronic circuitry to measure and process the outputs of the strain gauges. The circuitry may also include amplifiers to enhance the readings from the gauges and a memory for storing data. U.S. Pat. No. 4,977,783 discloses a chain link in which strain gauges are placed the sides of one or more links. The strain gauges are connected in a Wheatsone bridge. The voltage output from the bridge is provided to a remotes sensor for determining forces.

Prior art load links lack practicality to measure deployment forces in connection with a personal parachute system. Additional weight and bulk may hinder packing and operation of the parachute. Additionally circuitry needed for operating the load link needs to be located and attached to the parachute. Therefore, a need exists for a simple load link for use with parachutes that can be accommodated into any harness container system.

### SUMMARY OF THE INVENTION

The present invention substantially overcomes the deficiencies of the prior art by providing a load link with two tension beams between a pair of connectors. Strain gauges are attached to the tension beams for determining the forces exerted on the load link. According to one aspect of the invention, the tension beams and connectors are unitarily formed of a high strength steel. According to another aspect of the invention, electronic circuitry are positioned between the torsion beams. The electronic circuitry may include a Wheatsone bridge and amplifier for the strain gauge signals, processing circuitry and/or memory. According to another aspect of the invention, The connectors may be dimensioned to accommodate straps from a typical parachute harness.

### BRIEF DESCRIPTION OF THE DRAWINGS

FIG. 1 is a front view of load measurement device according to a first embodiment of the present invention.

FIG. 2 is a front view of the load measurement device of FIG. 1 attached to straps in a parachute system.

FIG. 3 is a side view of the load measurement device of FIG. 2.

FIG. 4 is a top view of a load measurement device according to a second embodiment of the present invention.

### DETAILED DESCRIPT ION OF PREFERRED EMBODIMENTS

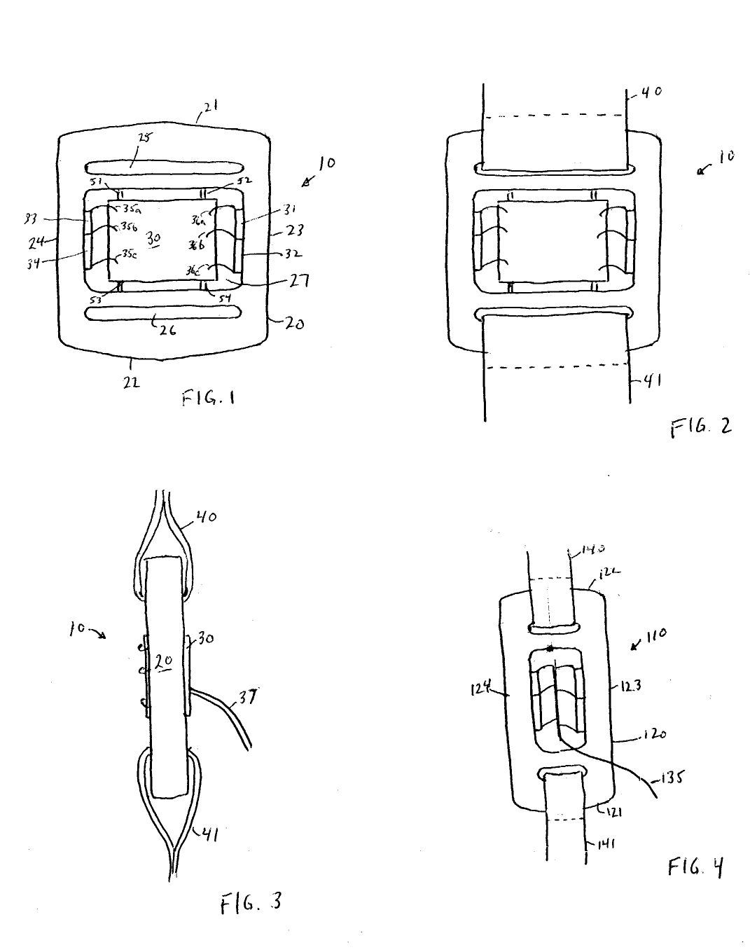

The present invention provides an improve load measurement device for use in a parachute system. As illustrated in FIG. 1, a first embodiment of the load measurement device 10 includes a load link 20 designed to operate within a parachute system and accompanying electronics 30 for signal conditioning the strain gauge sensors mounted on the link 20. The load link is formed as a flat link of steel having three elongated holes 25, 26, 27 through it. Two holes 25, 26 form connectors 21, 22 at either end of the load link. The connectors 21, 22 can be attached to straps 40, 41 of a parachute as illustrated in FIG. 2. The third hole 27 forms two tension beams 23, 24 on either side of the load link 20. Stresses from the straps 40, 41 are transferred through the connectors 21, 22 to the tension beams 23, 24.

According to an embodiment of the present invention, the load link 20 is formed, by forging, machining, or milling, from a 17-4 ph steel and then hardened and grain densified to ph900. Such a structure provides the load link 20 with a strength in excess of 200,000 psi. The load link may have different dimensions or be made from other high strength alloys. However, according to an embodiment for use with parachutes, the load link 20 is approximately a square approximately 1.25 on each side. The first two holes 25, 26 are each approximately 1 inch long and ⅛ inch wide. The center hole is approximately 1 inch long and ⅝ inch wide. The tension beams are approximately ⅛ inch wide. The load link has a depth of about ⅛ inch. The construction of the load link in this manner provides sufficient strength for use in the harness of the parachute as well as allowing sufficient distortion for effective measurement of loads.

Four strain gauges 31, 32, 33, 34 are bonded to the surfaces of the tension beams 23, 24 facing the hole 27. The stain gauges 31, 32, 33, 34 are used to measure distortion of the tension beams 23, 24 for determining load. According to an embodiment of the present invention, electronic circuitry 30 is placed within hole 27 of the load link 20. The electronic circuitry 30 is attached at various points 51, 52, 53, 54 to the connectors 21, 22 of the load link 20. Of course, a different attachment mechanism could be used. Wires 35a-35c, 36a36c connect the strain gauges to the electronic circuitry 30. According to an embodiment of the invention, as illustrated in FIG. 1, three wires 35a, 35b, 36c are used to connect the two strain gauges on a torsion beam 24 to the electronic circuitry. One wire 35b connects to an end of each of the two strain gauges; the other wires 35a, 35b connect to the other end of the strain gauges. Depending upon the desired operation of the load measuring device 10, different electronic circuitry can be included. According to an embodiment of the invention, the wires from the strain gauges are connected by the electronic circuitry in a Wheatsone bridge configuration. The electronic circuitry includes a signal amplifier for providing the excitation and voltage signal output of the Wheatsone bridge. Output wires 35 (FIG. 3) provide the voltage output to a data acquisition device, such as a computer or processor (not shown). The data acquisition device may be attached elsewhere to the jumper or the harness. The data acquisition device receives and records the output voltage. It may also process the voltage to determine load forces. Preferably, the data acquisition device determines and stores the values for load forces over a period of time. The data acquisition device could be programmed to output the information in a human readable form or to transfer the data to through a connection to another computer for storage or analysis.

FIG. 4 illustrates a second embodiment of the load measuring device 110 of the present invention. In the second embodiment, the electronic circuitry is removed from the load measuring device. The second embodiment includes a load link 120 having two connectors 121, 122 and two tension beams 123, 124. The tension beams are dimensioned approximately the same as in the first embodiment. However, by elimination of the electronic circuitry, the load link 120 can be smaller for use in suspension lines or other parts of the parachute. Four strain gauges 131, 132, 133, 134 are placed on the two tension beams 123, 124. Wires 135 from the strain gauges extend from the load link and would be attached to additional circuitry (not shown) for processing and storage. The second embodiment of the invention may be formed as a flat shim tension beam through stamping or photo etching using one or two tension beams.

While the present inventions have been described with a certain degree of particularity, it is obvious from the foregoing detailed description that one skilled in the art may make one or more modifications which are suggested by the above descriptions of the novel embodiments.

1. A load measuring device comprising:
a load link including two tension beams;
a plurality of strain gauges, each of the strain gauges being attached to one of the tension beams; and
electronic circuitry connected to the strain gauges for signal conditioning, being positioned between the two tension beams.

2. The load measuring device according to claim 1, wherein the load link further includes:
two connectors, wherein one connector is connected to an end of each of the two tension beams and another connector is connected to another end of each of the two tension beams.

3. The load measuring device according to claim 2, wherein each of the two connectors are attachable to a part of a parachute harness.

4. The load measuring device according to claim 2, wherein each of the two connectors are attachable to a part of a suspension line of a parachute.

5. The load measuring device according to claim 1, further comprising:
a data acquisition device receiving an output of the electronic circuitry.

6. The load measuring device according to claim 1, wherein the load link is formed of a high strength steel.

7. A load measuring device for a parachute comprising:
a load link including two tension beams;
a plurality of strain gauges, each strain gauge being attached to one of the tension beams;
a plurality of wires attached to the strain gauges for providing outputs of the strain gauges; and
a data acquisition device attached to the plurality of wires for processing the outputs from the strain gauges.

8. The load measuring device according to claim 7, wherein the load link is formed of a high strength steel.

9. The load measuring device according to claim 7, wherein the load link further includes:
two connectors, wherein one connector is connected to an end of each of the two tension beams and another connector is connected to another end of each of the two tension beams.

10. The load measuring device according to claim 9, wherein each of the two connectors are attachable to a part of a harness of a parachute.

11. The load measuring device according to claim 9, wherein each of the two connectors are attachable to a part of a suspension line of a parachute.

12. A load measuring device comprising a tension beam formed from a thin sheet of metal, and a plurality of strain gauges attached to the tension beam.

13. The load measuring device according to claim 12, wherein the tension beam is formed by one of metal etching, stamping, laser cutting thin sheet stock.
